(19) United States
(12) Patent Application Publication
(10) Pub. No.: US 2003/0135574 A1
(43) Pub. Date: Jul. 17, 2003

(54) Independent notification of urgent messages

(76) Inventor: Frederick Murray Burg, West Long Branch, NJ (US)

Correspondence Address: AT&T CORP., P.O. BOX 4110, MIDDLETOWN, NJ, 07748, US

(21) Appl. No.: 10/027,002

(22) Filed: Dec. 20, 2001

(51) Int. Cl. G06F 15/16

(52) U.S. Cl. 709/207

(57) ABSTRACT

A sender of a message may request independent notification of the message to a recipient by requesting such notification in the message itself. After creating such a message with a request for such notification, the sender launches the message into a network for ultimate delivery to the recipient. Upon receipt of the message, the network checks whether the sender requested independent notification of the message recipient. If the network determines that the sender requested independent notification, the network provides such notification to the recipient.

### TECHNICAL FIELD

This invention relates to a technique for providing independent notification to a message recipient to alert the recipient of an urgent message.

### BACKGROUND ART

E-mail has become a very familiar communications media. Many individuals use e-mail regularly to send messages for both business and personal activities. E-mail communication affords the advantage of creating a tangible record for easy storage as well as offering the opportunity to send and receive communications virtually instantaneously. Currently, there exist a variety of software programs for creating and sending e-mail messages, including Microsoft Outlook, available from Microsoft Corporation, Redmond, Wash. Most e-mail programs provide a mechanism for enabling the sender to alert the recipient that the particular e-mail message is of an urgent nature. Thus, a recipient who is currently “on-line” will know which of his/her messages warrants immediate attention.

To determine whether a message recipient is on-line, many Internet Service Providers (ISPs) offer so-called “instant messenger” service whereby a subscriber may designate one or more individuals as members of a particular group. Each time any member of the particular group becomes available (i.e., the group member goes on-line), the subscriber of the instant messenger service receives a notification. Some instant messenger services allow members of the same particular group to communicate with each other such that a message entered by one subscriber appears in near real time on the computer of one or message recipient(s) in the same particular group.

The above-described mechanisms work well if the message recipient is currently on-line. However, the message recipient may not currently enjoy an Internet connection, and thus may lack the ability to receive a message in a timely fashion. Once the intended recipient goes on-line and does retrieve the message, the timeliness of the message may become lost, defeating the very purpose of the urgent message notification.

Currently, some e-mail networks independently notify a message recipient of the arrival of an incoming message. For purposes of discussion, independent notification means notifying the message recipient by a mode independent of which the message was sent. Typical independent notification mechanisms include telephone and pagers. Present-day e-mail networks provide an independent notification for every message, or at least for messages of a particular category, as designated by the recipient, such as all messages from a particular sender. However, such networks do not take into account the desire of the sender regarding independent notification of the recipient for a particular message and not for another message.

Thus, there is a need for a technique for providing independent message notification, typically by way of a telephone call, to a recipient of a message at the request of the sender to alert the recipient to retrieve the message.

### BRIEF SUMMARY OF THE INVENTION

Briefly, in accordance with one aspect of the invention, a message recipient may receive independent notification of a message at the request of the message sender. To effectuate such independent notification, the sender, upon creating the message, will designate in a message header a request for independent notification of the message recipient. The sender launches the message into a communications network for ultimate delivery to the recipient. Upon receipt of the message, the network checks whether the sender requested independent notification of the message recipient. If the network determines that the sender requested independent notification, the network provides such notification to the recipient.

The message sent by the sender may advantageously specify the type of independent notification the recipient should receive, such as a telephone call, facsimile or page. To that end, the independent notification indication included within the message may specify a recipient identifier, such as a telephone number, that identifies the recipient to facilitate the notification. In the absence of any such recipient identifier, the network may query a database using the message address (e.g., the recipient's e-mail address) to obtain the recipient identifier for the independent notification.

### BRIEF DESCRIPTION OF THE DRAWINGS

FIG. 1 illustrates a block schematic diagram of a communications network for providing a message recipient with independent notification of the message in accordance with the desire of the message sender; and

FIG. 2 illustrates in flow-chart form the steps associated with providing the message recipient with such independent notification.

### DETAILED DESCRIPTION

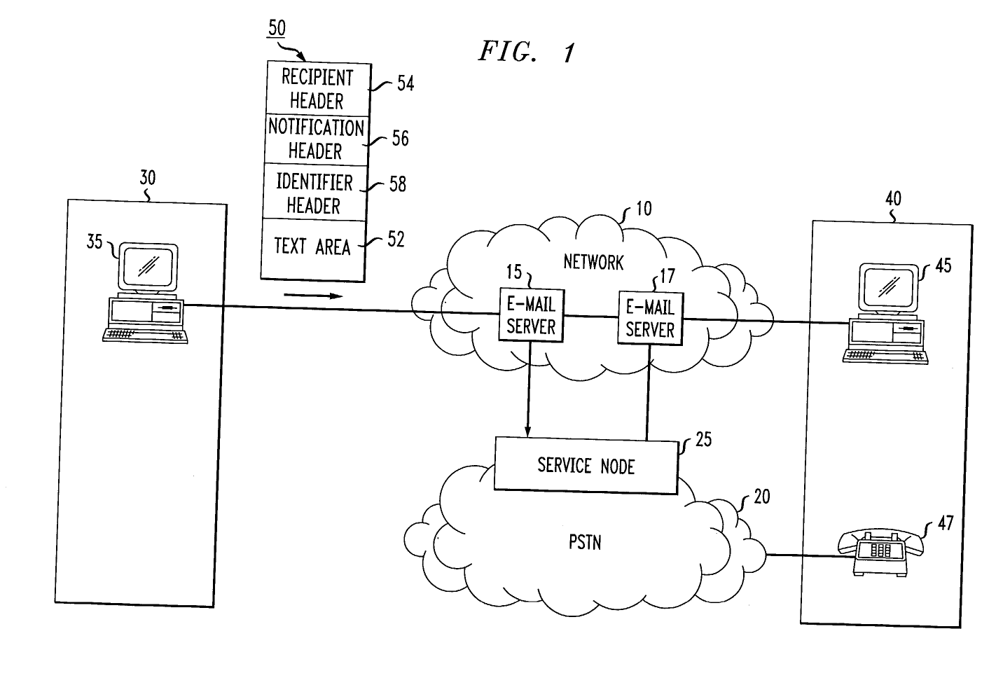

FIG. 1 illustrates a block schematic diagram of a network architecture for providing a message recipient with independent notification of a message (i.e., notification independent of the mode of communicating the message) in accordance with the request of the message sender. As depicted in FIG. 1, a communications network 10, such as the Internet, includes at least one mail server for communicating e-mail through the network. In the illustrated embodiment, the network 10 includes a pair of linked email servers 15 and 17, each serving a separate one of network communications devices 35 and 45, residing at a separate one of subscriber premises 30 and 40, respectively, that may each take the form of a personal computer, computer terminal or other device having messaging capability.

In the illustrated embodiment, the network communications devices 35 and 45 each have client software (e.g., an e-mail program) that enables each to send and receive e-mail messages. Similarly, each of the e-mail servers 15 and 17 includes appropriate logic (hardware and/or software) that enables each server to receive an e-mail message from a corresponding sender and forward the e-mail to a recipient's e-mail sever for receipt by the recipient. Rather than receive a message from a network communications device acting as a message sender, an e-mail server (e.g., e-mail server 15) could receive an e-mail (text) message from a platform (not shown) in the network 10 that converts a received facsimile message to an e-mail message destined for an e-mail recipient. The email server receiving the “fax” e-mail message would then forward the message to the recipient's e-mail server (e.g., e-mail server 17) in the same manner as a regular e-mail message received from a network communications device. Depending on the traffic within the network 10 and the priority assigned to e-mail messages, a recipient often can receive an e-mail message from a sender in near real time.

The ability of a message recipient to receive (and acknowledge) an e-mail message depends on whether the recipient is available, i.e., whether the recipient is “online.” While off line, the recipient has no ability to receive (and acknowledge) the message. Under such circumstances, the timeliness of the e-mail message may become lost.

In accordance with the invention, a message recipient can receive an independent notification of an e-mail message at the request of the message sender. In the preferred embodiment of FIG. 1, the independent notification comprises a telephone call sent automatically to the telephone set associated with the message recipient when the sender has requested the message recipient receive independent notification.

To have the recipient receive an independent notification of an e-mail message by telephone, a sender first creates an e-mail message, represented as message block 50, via the sender's network communications device 35. The message block 50 includes a text area 52 that contains the desired text message entered by the subscriber. (The sender may also attach one or more files as well.) In addition to the text area, the message block 50 includes a recipient header 54 that contains an e-mail address (or alias) entered by the sender for each recipient destined to receive the message.

In accordance with the invention, the message block 50 includes a notification header 56 via which the sender can designate whether the recipients should receive independent notification of the e-mail message. The notification header 56 typically includes a check box or other similar type of mechanism for allowing the sender to make an independent message notification designation. Indeed, the notification header 56 could include several boxes to allow the sender to designate one or more different types of notification (e.g., telephone, page or fax, as examples).

Although not essential to the implementation of the invention, the message block 50 may also include a recipient notification identifier header 58 via which the sender enters an identifier of the recipient (e.g., a telephone number) to enable launching of the independent notification to that recipient. In the case of multiple recipients, the recipient notification identifier header 58 would include the identifier for each recipient. To the extent that the message sender desires to send independent notifications via two (or more) different telephones (i.e., a landline telephone and a wireless telephone), the recipient notification identifier header 58 would include the identifier for each type of telephone. In the absence of the recipient notification identifier header 58, the recipient's e-mail server will perform a database query to establish a recipient identifier for notification purposes when the e-mail message block 50 contains a designation for independent message notification. The recipient's e-mail server will also perform such a database query when the recipient notification identifier header 58 exists but hasn't been populated by the sender.

As an alternative, the sender's e-mail program or server may prompt the sender, after the “Send” button has been clicked, to determine whether the recipient should receive independent notification of the e-mail message. If so, the sender may also be prompted for one or more recipient notification identifiers.

To effect independent notification by telephone, the e-mail server 17 that serves the network communications device 45 enjoys a connection to a service node 25 in a Public Switched Telephone Network (PSTN) 20. FIG. 1 depicts the PSTN 20 as serving a single telephone set 47 at the recipient's premises 40. The service node 25 responds to commands from each e-mail server. To effect independent notification of a message received for a recipient (e.g., network communications device 45), the corresponding email server (e.g., mail server 17) signals the service node 25 to launch a telephone call to the message recipient's telephone (e.g., the telephone 47). The launched call would contain a pre-recorded message indicating that the recipient had an e-mail message. Rather than, or in addition to, launching a call to the telephone set 47 associated with the recipient's premises 40, the service node 25 could launch a call to one or more of the message recipient's wireless telephone, pager, facsimile machine or other telephone-like device (not shown) associated with the message recipient. In the case of a call launched to a facsimile machine, the service node 25 would provide a facsimile message alerting the recipient of the text message.

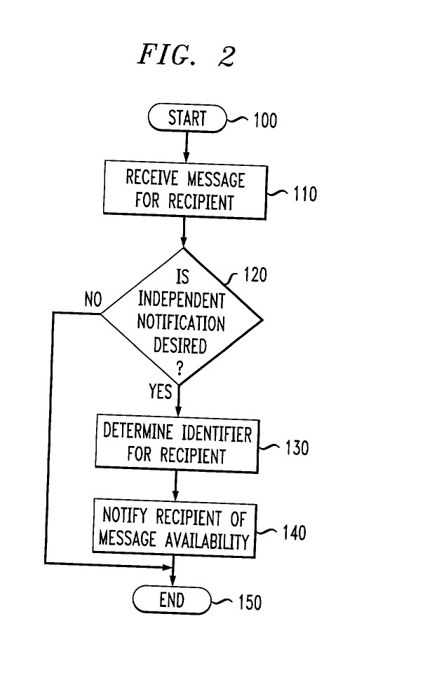

FIG. 2 illustrates in flow-chart form the steps associated with the method of the invention for providing independent notification of an incoming message to a recipient at the request of the message sender. The method of FIG. 2 commences upon execution of a start step 100 during which the message sender creates the message block 50 of FIG. 1. In creating the message block 50, the message sender may request independent notification of the message recipient by making such a designation in the notification header 56 of FIG. 1. Thereafter, the sender launches the e-mail message into the network 10 of FIG. 1 destined for the recipient. The message passes from the sender's e-mail server (e.g., e-mail server 15 of FIG. 1) to the recipient's e-mail server (e.g., e-mail server 17) during step 110 of FIG. 2. Upon receiving an e-mail message destined for the recipient, the recipient's e-mail server checks whether the message sender requested that the recipient receive an independent notification. To that end, the recipient's e-mail server checks the notification header 56 in the message block 50. If the recipient's e-mail server finds that the sender requested independent notification, then the recipient's e-mail server determines the identifier (e.g., telephone number) for each recipient requested to receive independent notification of the received message during step 130. The recipient's e-mail server performs this step by first examining the recipient notification identifier header 58 for an identifier entry. In the absence of any such entry (or in the absence of the recipient notification identifier header itself), the recipient's email server queries a database (not shown) using the message recipient's e-mail address (or alias) as the key.

After establishing the identifier for the recipient requested to receive the independent notification, the recipient then receives the independent notification during step 140. As discussed previously, in the illustrated embodiment of FIG. 1, the message recipient receives the independent notification via a telephone call to the recipient's telephone set 47 of FIG. 1. However, as discussed, the independent notification could occur by other mechanisms as well. Following step 140, the process ends (step 150) which also will occur directly after step 120 when the recipient's e-mail server determines that the sender did not request independent notification.

With minor modification, the above-described method could also provide independent notification to a message recipient of a facsimile message launched into the PSTN 20. One approach would have the facsimile sender launch a call to a special platform in the PSTN 20, such as service node 25 and thereafter enter a DTMF keystroke or series of keystrokes to request independent notification to the message recipient. The message recipient would then enter the facsimile telephone number for the recipient, and optionally, the recipient identifier (e.g., the telephone number) for providing the independent notification. The special platform (e.g., the service node 25) would route the facsimile message to the recipient's facsimile machine while also launching a telephone call to provide the independent notification to the recipient.

Other approaches also exist for providing independent notification in connection with a facsimile message. Rather than have the message sender enter one or more DTMF keystrokes to request independent notification, the message sender could include the request for independent notification in the facsimile message header, assuming the same were standardized in some fashion to permit easy recognition of the request.

The notification provided to the recipient may take many forms. In a simplest form, it could, for example, be a telephone call announcing “you have an urgent e-mail message.” An enhancement would include the sender's e-mail address, name, time and date of the e-mail's receipt, or any combination of these. Other enhancements of the notification message are also possible.

The foregoing describes a technique for providing an independent notification of a message to a message recipient at the request of the sender.

The above-described embodiments merely illustrate the principles of the invention. Those skilled in the art may make various modifications and changes that will embody the principles of the invention and fall within the spirit and scope thereof.

What is claimed is:

1. A method for providing independent message notification to a message recipient at the request of the sender, comprising the steps of:
receiving in a communications network the message from the sender;
determining whether the sender requested that the message recipient receive independent notification of the message; and if so, then
establishing an identifier for the recipient; and
launching an independent notification to the message recipient identified by the identifier.

2. The method according to claim 1 wherein the independent notification includes a telephone call to the recipient.

3. The method according to claim 2 wherein the telephone call is routed to one of a telephone set, a pager and facsimile machine associated with the message recipient.

4. The method according to claim 1 wherein the message launched by the sender comprises an e-mail message.

5. The method according to claim 4 wherein the network determines whether the sender requested independent notification by examining a recipient notification header in the e-mail message that will have a predetermined designation when the sender has requested independent notification.

6. The method according to claim 5 wherein the network establishes an identifier for the recipient by examining a recipient notification identifier header in the email message to determine if the sender has populated the recipient notification identifier header with information identifying the recipient.

7. The method according to claim 6 wherein the network establishes an identifier for the recipient by querying a database in accordance with a message address for the recipient.

8. A method for providing voice notification to a message recipient at the request of the sender to alert the recipient of an incoming message, comprising the steps of:
receiving in a communications network the message from the sender;
determining whether the sender requested that the message recipient receive voice notification of the message; and if so, then
establishing an identifier for the recipient; and
launching a voice telephone call to the message recipient identified by the identifier.

9. The method according to claim 8 wherein the message launched by the sender comprises an e-mail message.

10. The method according to claim 9 wherein the network determines whether the sender requested voice notification by examining a recipient notification header in the e-mail message that will have a predetermined designation when the sender has requested voice notification.

11. The method according to claim 10 wherein the network establishes an identifier for the recipient by examining a recipient notification identifier header in the email message to determine if the sender has populated the recipient notification identifier header with information identifying the recipient.

12. The method according to claim 11 wherein the identifier comprises a telephone number.

13. The method according to claim 10 wherein the network establishes an identifier for the recipient by querying a database in accordance with a message address for the recipient.

14. The method according to claim 13 wherein the identifier comprises a telephone number.
